(19) United States
(12) Patent Application Publication
(10) Pub. No.: US 2014/0132713 A1
(43) Pub. Date: May 15, 2014

(54) IMAGE ENCODING DEVICE, IMAGE ENCODING METHOD, IMAGE DECODING DEVICE, IMAGE DECODING METHOD, AND COMPUTER PROGRAM PRODUCT

(71) Applicant: Kabushiki Kaisha Toshiba, Tokyo (JP)

(72) Inventors: Tatsuya TANAKA, Kanagawa (JP); Nakaba Kogure, Kanagawa (JP); Shinichiro Koto, Tokyo (JP); Tomoya Kodama, Kanagawa (JP); Wataru Asano, Kanagawa (JP); Youhei Fukazawa, Tokyo (JP)

(73) Assignee: Kabushiki Kaisha Toshiba, Tokyo (JP)

(21) Appl. No.: 14/051,486

(22) Filed: Oct. 11, 2013

Related U.S. Application Data
(63) Continuation of application No. PCT/JP2011/063536, filed on Jun. 13, 2011.

(51) Int. Cl. H04N 19/597

(52) U.S. Cl. CPC H04N 19/00769
USPC 348/43

(57) ABSTRACT

According to an embodiment, an image encoding device includes a setting unit and an obtaining unit. The setting unit sets an corresponding block corresponding to a target block to be encoded in a first parallax image at a first viewpoint on the basis of first depth information of the first parallax image and a positional relationship between the first viewpoint and a second viewpoint of each of one or more second parallax images, sets a shared block in a search area including the target block and area adjacent to the corresponding block, and generates specifying information that indicates a positional relationship between the shared block and the corresponding block. The corresponding block is in the one or more second parallax images. Encoding information of the shared block is shared. The obtaining unit obtains the encoding information on the basis of the specifying information.

### CROSS-REFERENCE TO RELATED APPLICATION

This application is a continuation of PCT international Application No. PCT/JP2011/063536, filed on Jun. 13, 2011, which designates the United States; the entire contents of which are incorporated herein by reference.

### FIELD

Embodiments described herein relate generally to an image encoding device, an image encoding method, an image decoding device, an image decoding method, and computer program products.

### BACKGROUND

Typically, a multiparallax image encoding/decoding device is known that performs projection transform with the use of camera parameters or depth information so as to determine a block corresponding to a target block for encoding from an already-encoded image at a different viewpoint, and shares the motion vector of that block and information specifying reference information.

However, in such a conventional technology, due an estimation error in the depth information or due to a coding distortion that gets applied, as well as due to an error occurring because of projection transform; it may not be possible to correctly determine a block corresponding to the target block for encoding. Moreover, the encoding information that can be shared becomes confined to the motion information. For that reason, in a conventional multiparallax image encoding/decoding device, it is difficult to enhance the encoding efficiency.

### BRIEF DESCRIPTION OF THE DRAWINGS

FIG. 1 is a diagram of an image encoding device according to a first embodiment;

FIG. 2 is a diagram for explaining an exemplary image encoding according to the first embodiment;

FIG. 3 is a diagram for explaining an exemplary setting of a corresponding macroblock according to the first embodiment;

FIG. 4 is a diagram for explaining an exemplary setting of a shared block according to the first embodiment;

FIG. 5 is a diagram illustrating an example of the shared block specifying information according to the first embodiment;

FIG. 6 is a diagram illustrating an example of sharing encoding information according to the first embodiment;

FIG. 7 is a flowchart of an encoding process according to the first embodiment;

FIG. 8 is a flowchart of a prediction process according to the first embodiment;

FIG. 9 is a diagram of an image decoding device according to a second embodiment;

FIG. 10 is a flowchart of a decoding process according to the second embodiment; and

FIG. 11 is a flowchart of a prediction process according to the second embodiment.

### DETAILED DESCRIPTION

According to an embodiment, an image encoding device includes a setting unit, an obtaining unit, a generating unit, and an encoding unit. The setting unit is configured to set an corresponding block corresponding to a target block to be encoded in a first parallax image at a first viewpoint on the basis of first depth information of the first parallax image and a positional relationship between the first viewpoint and a second viewpoint of each of one or more second parallax images, the corresponding block being in the one or more second parallax images, set a shared block in a search area including the target block and area adjacent to the corresponding block, the shared block whose encoding information is shared and generate specifying information that indicates a positional relationship between the shared block and the corresponding block. The obtaining unit is configured to obtain the encoding information of the shared block on the basis of the specifying information. The generating unit is configured to generate a prediction image on the basis of the obtained encoding information. The encoding unit is configured to generate encoded data based on the image and the prediction image.

### First Embodiment

In a first embodiment, the explanation is given about an image encoding device that receives an input image serving as a target image for encoding; divides the input image into macroblocks; and performs an encoding process on a target macroblock for encoding by sharing encoding information of an already-decoded parallax image at a different viewpoint than the viewpoint of the input image.

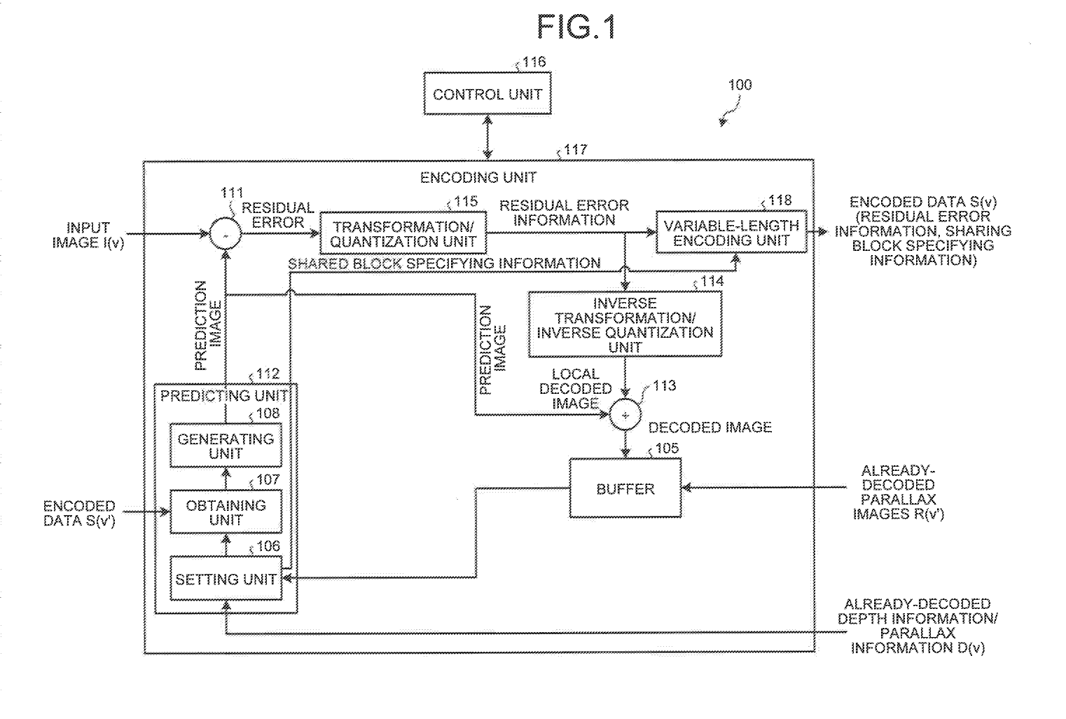

FIG. 1 is a block diagram of a functional configuration of an image encoding device according to the first embodiment. As illustrated in FIG. 1, an image encoding device 100 according to the first embodiment includes a control unit 116 and an encoding unit 117.

The encoding unit 117 receives an input image I(v) and divides the input image I(v) into macroblocks. Then, with respect to the macroblocks, the encoding unit 117 generates a prediction image with the use of encoding information of an already-decoded parallax image at a different viewpoint than the viewpoint of the input image. Subsequently, the encoding unit 117 generates encoded data S(v) that is obtained by encoding residual error information regarding a residual error between the prediction image and the input image I(v). The control unit 116 controls, in entirety, the image encoding process performed by the encoding unit 117.

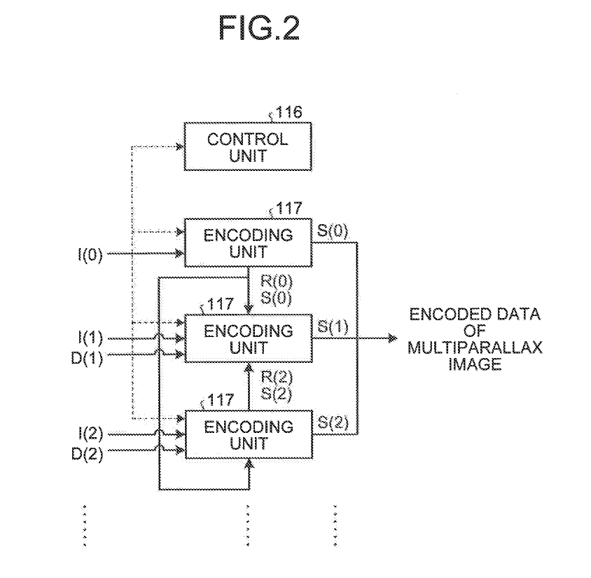

FIG. 2 is an explanatory diagram for explaining an example of the image encoding process. In FIG. 2, if the viewpoint of an input image is assumed to be “2” and if a different viewpoint is assumed to be “0”; then the encoding unit 117 generates a prediction image corresponding to the viewpoint “2” of the input image from encoded data S(0) of the different viewpoint “0” and corresponding depth information D(2).

As illustrated in FIG. 1, the encoding unit 117 includes a subtractor 111, a transformation/quantization unit 115, a variable-length encoding unit 118, an inverse transformation/inverse quantization unit 114, an adder 113, a predicting unit 112, and a buffer 105.

The encoding unit 117 receives the input image I(v). The subtractor 111 obtains the difference between a prediction image generated by the predicting unit 112 and the input image I(v), and generates a residual error as the difference therebetween.

The transformation/quantization unit 115 performs orthogonal transformation with respect to the residual error to obtain a coefficient of transformation, as well as quantizes the coefficient of transformation to obtain residual error information. Herein, for example, discrete cosine transform can be used as the orthogonal transformation. Then, the residual error information is input to the variable-length encoding unit 118 and the inverse transformation/inverse quantization unit 114.

The inverse transformation/inverse quantization unit 114 performs inverse quantization and inverse orthogonal transformation on the residual error information to generate a local decoded image. The adder 113 then adds the local decoded image and the predicted image to generate a decoded image. The decoded image is stored as a reference image in the buffer 105.

Herein, the buffer 105 is a memory medium such as a frame memory. The buffer 105 is used to store the decoded image as a reference image as well as to store an already-decoded parallax images R(v′) at a different viewpoint.

The predicting unit 112 generates a prediction image from the already-decoded parallax image R(v′) at the different viewpoint. Herein, the predicting unit 112 includes a setting unit 106, an obtaining unit 107, and a generating unit 108.

The setting unit 106 sets, from one or more parallax images at different viewpoints than the viewpoint of the input image (i.e., from the already-decoded parallax images R(v′) at different viewpoints that are stored in the buffer 105), a shared block, which is used to share encoding information at the time of encoding a target macroblock for encoding, on the basis of depth information D(v) of the input image I(v) and the positional relationship between the viewpoint position of the input image I(v) and the viewpoint positions of the already-decoded parallax images R(v′) at different viewpoints. Herein, the positional relationship between two viewpoint positions can be the positional relationship between the camera that captured the input image I(v) and the camera that captured an already-decoded parallax image R(v′) having a different viewpoint. More particularly, the setting unit 106 sets a shared block in the following manner.

Firstly, the setting unit 106 sets a corresponding macroblock, which is a macroblock in an already-decoded parallax image R(v′) at a different viewpoint that is stored in the buffer 105 and which is corresponding to a target macroblock for encoding in a parallax image at the viewpoint of the input image I(v).

More particularly, the setting unit receives depth information D(v) of the input image I(v), and sets a shared block with the use of the depth information D(v) and the camera parameters.

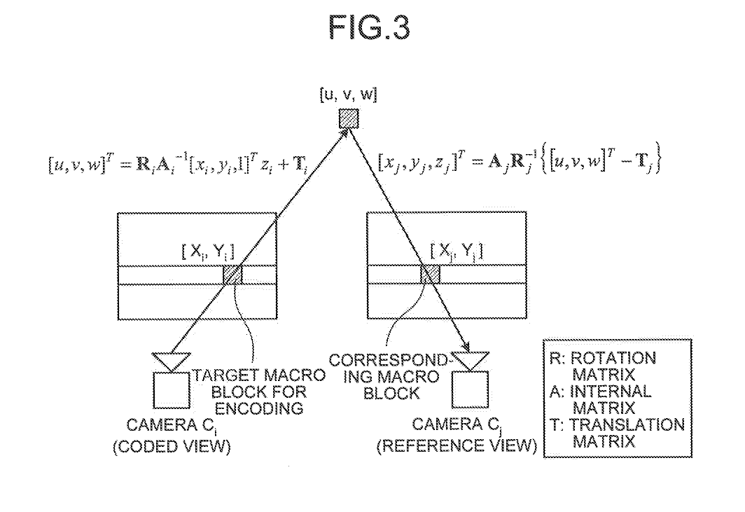

FIG. 3 is a diagram for explaining a setting process of a corresponding macroblock. The setting unit 106 calculates the coordinates of a corresponding macroblock corresponding to a target macroblock for encoding in the input image I(v), by performing projection transform with the use of Equation (1) and Equation (2) given below.

[u,v,w]^{T}=RᵢAᵢ⁻¹[xᵢ,yᵢ,1]zᵢ+Tᵢ (1)

[xⱼ,yⱼ,zⱼ]^{T}=AⱼRⱼ⁻¹{[u,v,w]^{T}−Tⱼ} (2)

Herein, each of “R”, “A”, and “T” is a camera parameter. “R” represents a rotation matrix of the camera; “A” represents an internal camera matrix; and “T” represents a translation matrix. Moreover, “z” represents a depth value that is the depth information D(v) of the input image I(v).

Thus, using Equation (1), the setting unit 106 projects, on three-dimensional space coordinates, a target macroblock for encoding present in a parallax image at a camera Cᵢ at the viewpoint of the target macroblock for encoding. Subsequently, using Equation (2), the setting unit 106 performs back projection to a parallax image at a camera Cⱼ at a different viewpoint, and sets a corresponding macroblock in an already-decoded parallax image R(v′) at a different viewpoint (reference image). Meanwhile, in case a corresponding macroblock is not found, the setting unit 106 performs the abovementioned projection transform regarding the next reference image stored in the buffer 105.

Then, as a search range, the setting unit 106 selects a search area that includes the corresponding macroblock in the already-decoded parallax image R(v′) at a different viewpoint as well as includes adjacent macroblocks around that corresponding macroblock.

Subsequently, from the macroblocks present in the search area of each reference image (each already-decoded parallax image R(v′) at a different viewpoint) that is stored in the buffer 105, the setting unit 106 sets a shared block as a macroblock for sharing encoding information.

More particularly, the setting unit 106 calculates an RD cost in the case when encoding information of each macroblock in the abovementioned search area is shared.

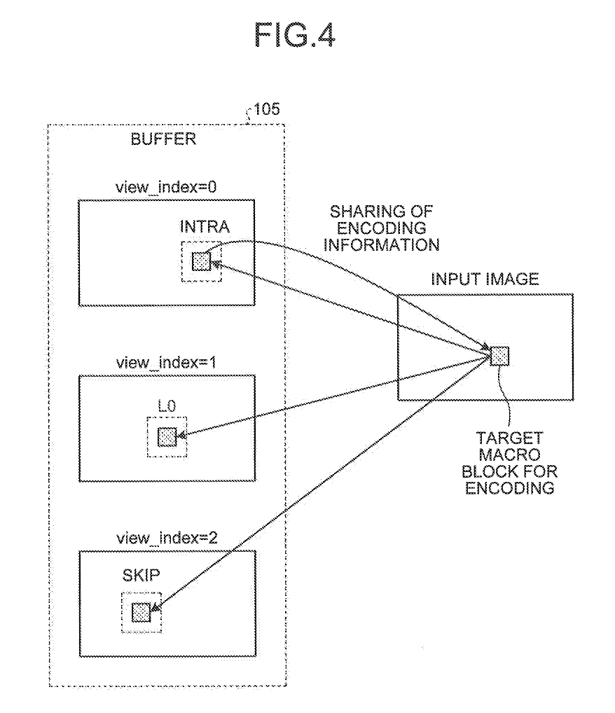

FIG. 4 is a diagram for explaining the operation of setting a shared block. The setting unit 106 calculates the RD cost using Equation (3) given below.

RD cost=Distortion+λ×Rate (3)

Herein, “Distortion” represents the residual error that occurs when encoding information of macroblocks is shared. “Rate” represents the amount of encoding performed when encoding information of macroblocks is shared. “λ” represents a coupling coefficient. Meanwhile, the details regarding the RD cost are given in Jacek Konieczny, Marek Domanski, Depth-based Inter-view Prediction of Motion Vectors for Improved Muitiview Video encoding, 3DTV-Conference: The True Vision-Capture, Transmission and Display of 3D Video (3DTV-CON), pp. 1-4, 2010 and Japanese Translation of PCT Application No. 2010-515400.

As illustrated in FIG. 4, using Equation (3), the setting unit 106 calculates the RD cost with respect to all reference images that are stored in the buffer 105 and with respect to all macroblocks present in the search area in each reference image. Then, the setting unit 106 determines the macroblock having the smallest RD cost to be the shared block.

Once the shared block is set, the setting unit 106 generates shared block specifying information that indicates the positional relationship between the corresponding macroblock and the shared block. Herein, in the first embodiment, the shared block specifying information includes “view_index”, which indicates the viewpoint of the reference image in which the shared block is present with a restriction that sharing of encoding information is possible only from the same timing, and includes “blk_index”, which indicates the relative position of the shared block with respect to the corresponding macroblock in a search area.

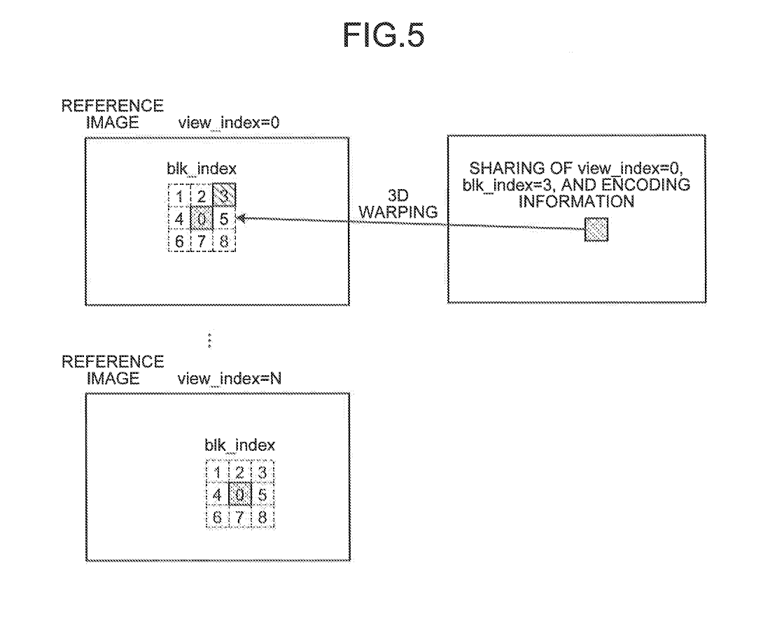

FIG. 5 is a diagram illustrating an example of the shared block specifying information. In FIG. 5, the explanation is given for an exemplary case when, in the search area of each reference image at a different viewpoint, the position of the corresponding macroblock is set to “0” and the macroblocks are numbered in sequence from top left to bottom right. In such a case, as illustrated in FIG. 5, assume that the RD cost is the smallest for the macroblock for which the number “3” represents the relative position from the corresponding macroblock in the search area of the reference image at the viewpoint “0”. In that case, the setting unit 106 generates “view_index=0, blk_index=3” as the shared block specifying information.

Returning to the explanation with reference to FIG. 1, the obtaining unit 107 receives encoded data S(v′) of a different viewpoint that includes the shared block set by the setting unit 106 (i.e., the shared block specified in the shared block specifying information). Then, either from the encoded data S(v′) of the different viewpoint or from the shared block, the obtaining unit 107 obtains encoding information used at the time of encoding the shared block. In the first embodiment, as the encoding information, the obtaining unit 107 obtains, for example, a prediction mode (PredMode), a motion vector (Mv), and an index (ref_index) that specifies the reference image.

Based on the encoding information obtained by the obtaining unit 107, the generating unit 108 generates a prediction image and outputs that prediction image. Thus, during the encoding of a target macroblock for encoding, the encoding information of the shared block in the already-decoded parallax image R(v′) at a different viewpoint is shared.

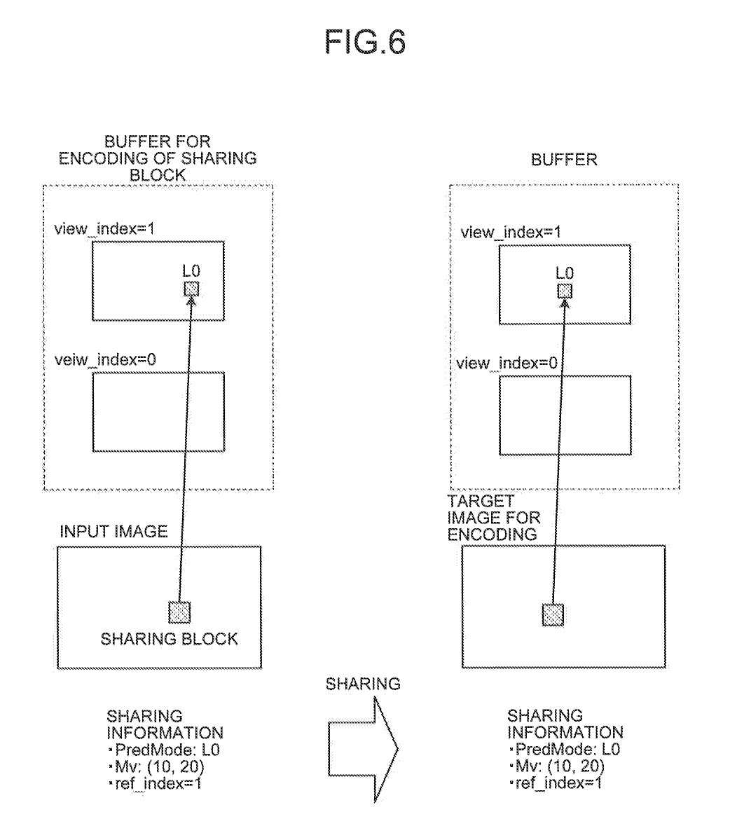

FIG. 6 is a diagram illustrating an example of sharing the encoding information. As illustrated in FIG. 6, when the generating unit 108 generates a prediction image from a target macroblock for encoding; a prediction mode (PredMode): L0 prediction, a motion vector (Mv): (10, 20), and an index (ref_index)=1 specifying the reference image are considered as the encoding information that was used at the time of encoding the shared block (macroblock) set with respect to that target macroblock for encoding.

Herein, although the encoding information used in the target macroblocks for encoding and the shared block is common, the reference images stored in the buffer 105 and used at the time of encoding the macroblocks are different. For that reason, the reference images that are referred to by the target macroblocks for encoding are different than the reference image that is referred to by the shared block.

The variable-length encoding unit 118 performs variable-length encoding on the residual error information that is output by the transformation/quantization unit 115, and generates the encoded data S(v). Moreover, the variable-length encoding unit 118 performs variable-length encoding on the shared block specifying information that is output by the setting unit 106, and adds the encoded shared block specific information to the encoded data. Thus, the variable-length encoding unit 118 generates the encoded data S(v) that includes the encoded residual error information and the encoded, shared block specifying information. Then, the variable-length encoding unit 118 outputs the encoded data S(v). Later, the encoded data S(v) is input to an image decoding device via a network or a storage media.

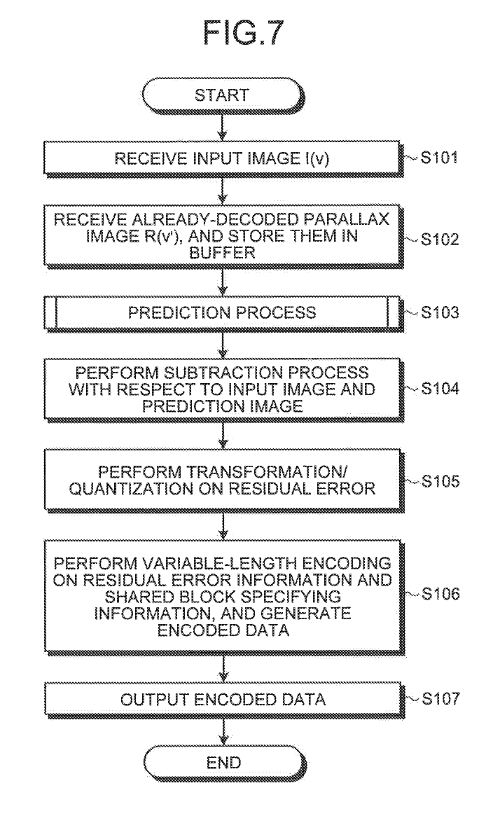

Explained below is an image encoding process performed by the image encoding device 100 that is configured in the manner described above according to the first embodiment. FIG. 7 is a flowchart for explaining a sequence of the image encoding process.

The encoding unit 117 receives an input image I(v) (Step S101). Herein, the input image I(v) that is received is divided into macroblocks of a predetermined size. Moreover, the encoding unit 117 receives one or more already-decoded parallax images R(v′) at different viewpoints than the viewpoint of the input image I(v), and stores those parallax images R(v′) as reference images in the buffer 105 (Step S102).

The predicting unit 112 receives already-decoded depth information D(v) of the input image I(v) and generates a prediction image with the use of the already-decoded parallax image R(v′) at a different viewpoint and with the use of the depth information D(v) (Step S103).

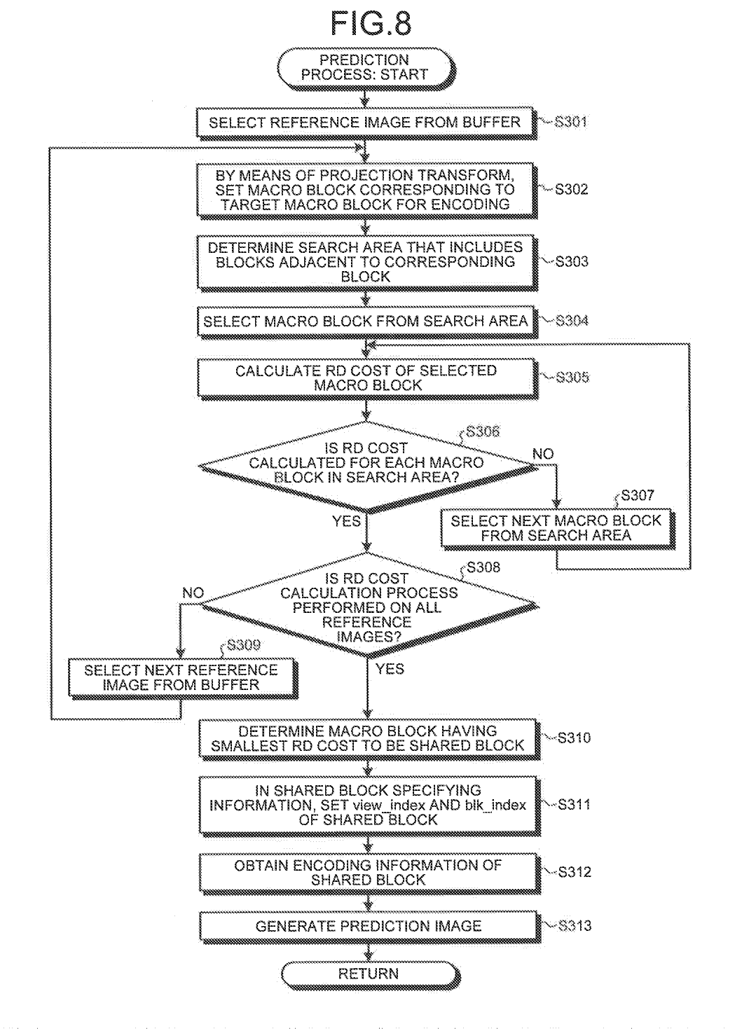

FIG. 8 is a flowchart for explaining a sequence of a prediction process. Firstly, the setting unit 106 selects a reference image from the buffer 105 (Step S301). Then, the setting unit 106 performs projection transform using Equations (1) and (2) given above, and sets a corresponding macroblock corresponding to the target macroblock for encoding (Step S302).

Then, in the reference image, the setting unit 106 determines a search area that includes the corresponding macroblock and adjacent macroblocks around the corresponding macroblock (Step S303). Subsequently, from among a plurality of macroblocks constituting the search area, the setting unit 106 selects a single macroblock (Step S304). Then, the setting unit 106 calculates the abovementioned RD cost of the selected macroblock using Equation (3) (Step S305). The setting unit 106 temporarily stores the calculated RD cost in a memory or the like (not illustrated).

Then, the setting unit 106 determines whether or not the RD cost has been calculated for each macroblock present in that search area (Step S306). If the setting unit 106 has not yet calculated the RD cost for each macroblock present in the search area (Not at Step S306), then the setting unit 106 selects the next macroblock in the search area for which the RD cost is not yet calculated (Step S307). Then, the system control returns to Step 3305, and the setting unit 106 calculates the RD cost for the selected macroblock (Step S305). In this way, the RD cost is calculated for each macroblock present in the search area.

At Step S306, once the setting unit 106 calculates the RD cost for each macroblock present in the search area (Yes at Step S306), the setting unit 106 determines whether or not the corresponding macroblock setting process and the RD cost calculation process has been performed on all reference images (all already-decoded parallax images R(v′) at different viewpoints) that are stored in the buffer 105 (Step S308).

If the setting unit 106 has not yet performed the corresponding macroblock setting process and the RD cost calculation process on all reference images (No at Step S308), then the setting unit 106 selects the next reference image from the buffer 105 for which the corresponding macroblock setting process and the RD cost calculation process is not yet performed (Step S309), and repeats the corresponding macroblock setting process and the RD cost calculation process from Step S302 to Step S307. In this way, the RD costs are calculated for all macroblocks placed around the corresponding macroblock in the search area in each reference image stored in the buffer 105, and the RD costs are stored in a memory (not illustrated).

Once the setting unit 106 has performed the corresponding macroblock setting process and the RD cost calculation process on all reference images (Yes at Step S308); then, from among the RD costs stored in the memory, the setting unit 106 determines the macroblock having the smallest calculated RD cost to be the shared block (Step S310).

Then, as the shared block specifying information, the setting unit 106 sets the value of “view_index”, which indicates the viewpoint of the reference image in which the set shared block is present, as well as sets the value of “blk_index”, which indicates the relative position of the shared block with respect to the corresponding macroblock in the search area of that reference image (Step S311). The setting unit 106 then outputs the shared block specifying information to the obtaining unit 107 and the variable-length encoding unit 118.

The obtaining unit 107 obtains the encoding information of the shared block, which is specified in the shared block specifying information, either from the encoded data S(v′) of the reference image including the shared block or from the shared block (Step S312). Then, according to the obtained encoding information (according to the prediction mode, the motion vector, and the index specifying the reference image), the generating unit 108 generates a prediction image (Step S313) and outputs the prediction image. This marks the end of the prediction process.

Returning to the explanation with reference to FIG. 7, once the prediction process at Step S103 is completed, the subtractor 111 performs a subtraction operation on the input image I(v) and the prediction image, and calculates a residual error (Step S104). Then, the transformation/quantization unit 115 performs orthogonal transformation on the residual error and obtains a coefficient of transformation, as well as quantizes the coefficient of transformation to obtain residual error information (Step S105).

The variable-length encoding unit 118 performs variable-length encoding on the residual error information and the shared block specifying information that is output by the setting unit 106 of the predicting unit 112, and generates the encoded data S(v) (Step S106). Then, the variable-length encoding unit 118 outputs the encoded data S(v) (Step S107).

In this way, in the first embodiment, in an already-decoded parallax image R(v′) at a different viewpoint than the viewpoint of the input image, from a search area formed around the corresponding macroblock corresponding to the target macroblock for encoding, the macroblock having the smallest RD cost is determined to be the shared block. Then, the encoding information of the shared block is used at the time of generating a prediction image from a target macroblock for encoding. Meanwhile, the encoding information is not limited to motion information. That is, in the first embodiment, the encoding process can be performed by sharing encoding information that is not limited to motion information among parallax images at mutually different viewpoints. Then, the shared block specifying information indicating the position of the set shared block can be added to the encoded data, followed by outputting the encoded data. That enables achieving reduction in the effect of an error in projection transform and to enhance the encoding efficiency.

In the first embodiment; “view_index”, which indicates the viewpoint of the reference image in which the shared block is present, and “blk_index”, which indicates the relative position of the shared block with respect to the corresponding macroblock in the search area, are used as the shared block specifying information. However, as the shared block can be specified, any other form of information can be used as long.

For example, the configuration can be such that a number ref_index that enables identification of a reference image is included in the shared block specifying information so as to specify the reference image. Moreover, regarding the relative position of the shared block with respect to the corresponding macroblock; the setting unit 106 can be configured to set, in the shared block specifying information, the relative position in the horizontal direction as ±H (H≧0) blocks and the relative position in the vertical direction as ±V (V≧0) blocks.

Furthermore, for example, in a manner in which the median of adjacent blocks is used in predicting the motion vector in H.264, the setting unit 106 can be configured to implement a method of using the median of adjacent blocks during prediction and to use the shared block specifying information in which the shared block is specified by means of prediction from surrounding blocks of the target macroblock for encoding.

Moreover, when intra prediction information is shared as the encoding information among the target macroblock for encoding and the shared block, the generating unit 108 can be configured to generate a prediction image from the macroblocks present in the parallax image in which the shared block is present. During intra prediction in which prediction is performed from adjacent macroblocks; for example, at an object boundary, when macroblocks are included in an object in which the target macroblock for encoding is in background and the adjacent macroblocks are in foreground, the pixel values in each macroblock are different. As a result, it is highly likely that the prediction is not accurate. Hence, the generating unit 108 can be configured to perform intra prediction with the use of macroblocks adjacent to the shared block in a parallax image at a different viewpoint than the viewpoint of the input image. From the viewpoint in which the shared block is present, the background that becomes an occluded region in the viewpoint of the input image appears within the image; and thus it becomes possible to predict the target macroblock for encoding with the use of the macroblocks of the occluded region (background area) that is absent in the viewpoint of the input image. As a result, it can be expected to have an enhancement in the prediction efficiency at the object boundary.

### Second Embodiment

In a second embodiment, the explanation is given about an image decoding device that, at the time of decoding the encoded data S(v) that is encoded by the image encoding device 100 according to the first embodiment, generates a prediction image by sharing the encoding information of the shared block specified in the shared block specifying information that is appended to the encoded data S(v). Herein, the encoded data S(v) that is to be decoded includes the codes of the residual error information and the shared block specifying information.

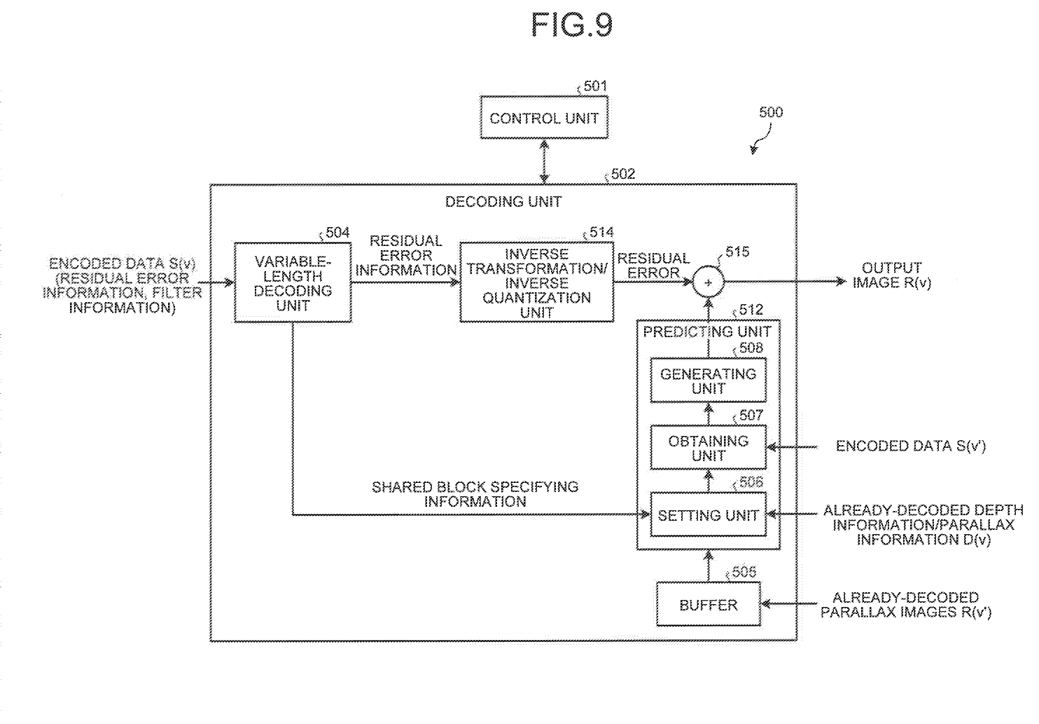

FIG. 9 is a block diagram of a functional configuration of the image decoding device according to the second embodiment. As illustrated in FIG. 9, an image decoding device 500 includes a control unit 501 and a decoding unit 502.

From the image encoding device 100 according to the first embodiment, the decoding unit 502 receives the encoded data S(v) that is an image to be decoded (hereinafter sometimes also referred to as “target image for decoding”); divides the encoded data S(v) into macroblocks; identifies, from the shared block specifying information appended to the encoded data S(v), the shared block in an already-decoded parallax image R(v′) at a different viewpoint than the viewpoint of the parallax image in the encoded data S(v); generates a prediction image using the encoding information of the shared block; and decodes the encoded data S(v). The control unit 501 controls the decoding unit 502 in entirety.

As illustrated in FIG. 9, the decoding unit 502 includes a variable-length decoding unit 504, an inverse transformation/inverse quantization unit 514, an adder 515, a predicting unit 512, and a buffer 505. Herein, the variable-length decoding unit 504, the inverse transformation/inverse quantization unit 514, and the adder 515 function as a decoding unit.

The variable-length decoding unit 504 receives the encoded data S(v) as the target image for decoding; performs variable-length decoding on the encoded data S(v); and obtains the residual error information (quantization orthogonal transformation coefficient information) and the shared block specifying information included in the encoded data S(v). The variable-length decoding unit 504 outputs the decoded residual error information to the inverse transformation/inverse quantization unit 514 and outputs the decoded, shared block specifying information to a setting unit 506 of the predicting unit 512.

Herein, the details of the shared block specifying information are identical to the details given in the first embodiment. Thus, the shared block specifying information indicates the positional relationship between the corresponding macroblock, which is set on the basis of the already-decoded depth information D(v) of the viewpoint of the encoded data S(v) and the positional relationship between the camera that captured the target image for decoding and the camera that captured an already-decoded parallax image R(v′) at the different viewpoint, and the shared block used to share the encoding information.

The shared block specifying information contains “view_index”, which indicates the viewpoint of the reference image in which the shared block is present, and contains “blk_index”, which indicates the relative position of the shared block with respect to the corresponding macroblock in a search area. However, in an identical manner to that described in the first embodiment, the shared block specifying information is not limited to those contents.

The inverse transformation/inverse quantization unit 514 performs inverse quantization and inverse orthogonal transformation on the residual error information, and outputs a residual error signal. The adder 515 generates a decoded image by adding the residual error signal and the prediction image generated by the predicting unit 512, and then outputs that decoded image as an output image R(v).

The buffer 505 is a memory medium such as a frame memory and is used to store, as reference images, the already-decoded parallax image R(v′) at the different viewpoint than the viewpoint of the target image for decoding.

The predicting unit 512 generates a prediction image by referring to the reference images stored in the buffer 505. As illustrated in FIG. 9, the prediction unit 512 includes the setting unit 506, an obtaining unit 507, and a generating unit 508.

Based on the shared block specifying information that is decoded by the variable-length decoding unit 504, the setting unit 506 sets a shared block for the purpose of sharing the encoding information with the target macroblock for decoding.

More particularly, the setting unit 506 sets the shared block in the following manner. Firstly, the setting unit 506 confirms the contents of the shared block specifying information received from the variable-length decoding unit 504; and reads, from the buffer 505, the already-decoded parallax image R(v′) at the different viewpoint than the viewpoint (view_index) specified in the shared block specifying information.

Then, from the already-decoded parallax image R(v′) at the different viewpoint (reference images) that are read from the buffer 505, the setting unit 506 sets a corresponding macroblock corresponding to the target macroblock for decoding. Herein, in an identical manner to the first embodiment, the corresponding macroblock setting process for setting a corresponding macroblock corresponding to the target macroblock for decoding, includes performing projection transform using Equations (1) and (2) given above. Moreover, the corresponding macroblock setting process is performed on the reference image specified in the shared block specifying information.

Then, as the shared block, the setting unit 506 determines the macroblock that is specified in the shared block specifying information and that is at the relative position (blk_index) from the corresponding macroblock of the shared block.

The obtaining unit 507 receives the encoded data S(v′) at a different viewpoint that includes the shared block set by the setting unit 506 (i.e., the shared block stored in the buffer 505 and specified in the shared block specifying information). Moreover, either from the encoded data S(v′) at the different viewpoint or from the shared block, the obtaining unit 507 obtains the encoding information used when the shared block was encoded. In the second embodiment, in an identical manner to the first embodiment; as the encoding information, the obtaining unit 507 obtains, for example, a prediction mode (PredMode), a motion vector (Mv), and an index (ref_index) specifying the reference image.

Based on the encoding information obtained by the obtaining unit 507, the generating unit 508 generates a prediction image and outputs the prediction image. Thus, during the encoding of the target macroblock for encoding, the encoding information of the shared block in the already-decoded parallax image R(v′) at the different viewpoint is shared. Meanwhile, the details regarding the generation of a prediction image by the generating unit 508 are identical to those described in the first embodiment.

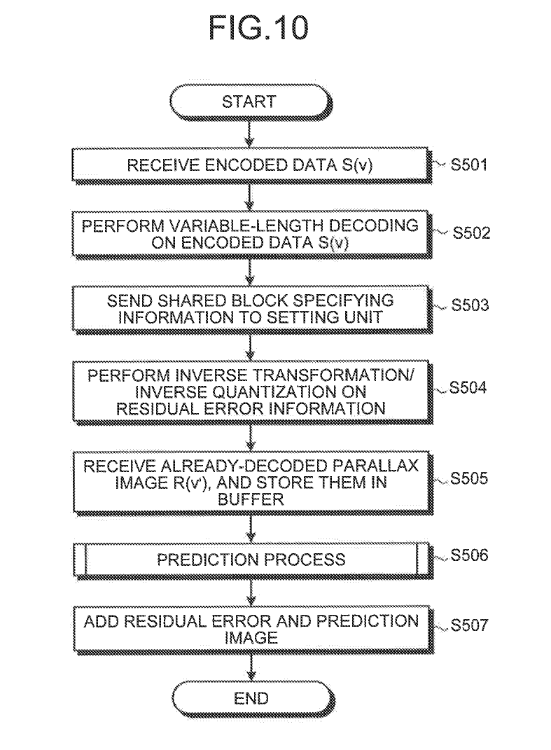

Explained below is a decoding process performed by the image decoding device 500 that is configured in the manner described above according to the second embodiment. FIG. 10 is a flowchart for explaining a sequence of the decoding process according to the second embodiment.

From the image encoding device 100, the variable-length decoding unit 504 receives the encoded data S(v), which is the target image for decoding, via a network or a storage medium (Step S501). Herein, the encoded data S(v) that is received is divided into macroblocks of a predetermined size.

Then, the variable-length decoding unit 504 performs variable-length decoding on the encoded data S(v) that has been input, and extracts the residual error information and the shared block specifying information from the encoded data S(v) (Step S502). Then, the variable-length decoding unit 504 sends the shared block specifying information to the setting unit 506 of the predicting unit 512 (Step S503).

The decoded residual error information is sent to the inverse transformation/inverse quantization unit 514. Then, the inverse transformation/inverse quantization unit 514 performs inverse quantization and inverse orthogonal transformation on the residual error information and generates a residual error signal (Step S504).

The decoding unit 502 receives input of one or more of already-decoded parallax images R(v′) at different viewpoints than the viewpoint of the target image for decoding (coding data S(v)) (Step S505).

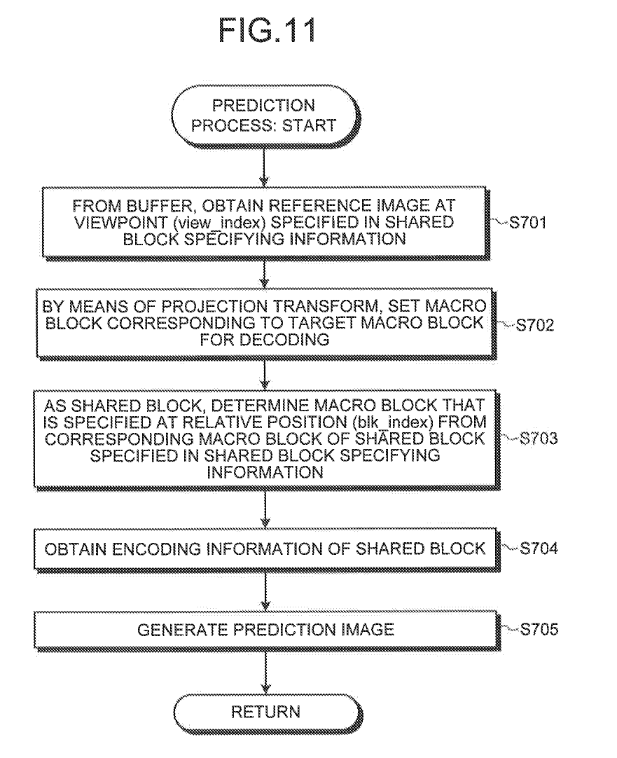

The predicting unit 512 performs a prediction process to generate a prediction image (Step S506). FIG. 11 is a flowchart for explaining a sequence of the prediction process according to the second embodiment.

From the buffer 505, the setting unit 506 obtains the already-decoded parallax image (v′) at the viewpoint (view_index) specified in the shared block specifying information that is received from the variable-length decoding unit 504 (Step S701). Then, in the already-decoded parallax image R(v′) at the different viewpoint that has been read from the buffer 505, the setting unit 506 sets the corresponding macroblock corresponding to the target macroblock for decoding (Step S702). Subsequently, as the shared block, the setting unit 506 determines the macroblock that is specified at the relative position (blk_index) from the corresponding macroblock of the shared block specified in the shared block specifying information (Step S703).

The obtaining unit 507 obtains the encoding information of the set shared block either from the encoded data S(v′) of the reference image including the shared block or from the shared block (Step S704). Then, according to the obtained encoding information (the prediction mode, the motion vector, and the index specifying the reference image), the generating unit 508 generates a prediction image (Step S705) and outputs the prediction image. This marks the end of the prediction process.

Returning to the explanation with reference to FIG. 10, once the prediction process at Step S506 is completed, the adder 515 generates a decoded image by adding the residual error, which is output by the inverse transformation/inverse quantization unit 514 at Step S504, and the prediction image, which is generated by the predicting unit 512; and outputs the decoded image as the output image R(v) (Step S507).

In this way, in the second embodiment, in an already-decoded parallax image R(v′) at a different viewpoint than the viewpoint of the target image for decoding; the encoding information of the shared block, which is specified in the shared block specifying information appended to the encoded data S(v) input from the image encoding device 100, is used at the time of generating a prediction image from the target macroblock for decoding. Meanwhile, the encoding information is not limited to motion information. That is, in the second embodiment, the decoding process can be performed by sharing encoding information that is not limited to motion information among parallax images at mutually different viewpoints. That enables achieving reduction in the effect of an error in projection transform and to enhance the encoding efficiency.

Modifications

It is possible to implement various modifications in the image encoding device 100 according to the first embodiment and in the image decoding device 500 according to the second embodiment.

First Modification

In the image encoding device 100 according to the first embodiment as well as in the image decoding device 500 according to the second embodiment; the explanation is given for a case in which a prediction mode, a motion vector, and information specifying a reference image constitute the encoding information that is shared at the time of generating a prediction image. However, as long as the necessary information for image decoding is specified, the encoding information is not limited to the contents mentioned above. For example, as the encoding information to be shared, either only the prediction mode and the information specifying a reference image can be used or only the motion vector can be used. Thus, from among the three sets of information mentioned above, one or more sets of information can be appropriately combined to form the encoding information to be shared.

Second Modification

Meanwhile, in the image encoding device 100, it is also possible to use the residual error information as the encoding information. For example, in the image encoding device 100, it is possible to implement a method in which the prediction image generated by sharing the encoding information is not encoded as well as the residual error information of the target macroblock for encoding is not encoded, and the residual error information in the shared block is used without modification. Alternatively, it is also possible to implement a method in which the difference with the residual error information in the shared block is encoded. In the case of implementing such methods, the image encoding device 100 can be configured to encode the information indicating whether or not the residual information is to be shared and can be configured to append that encoded information to the encoded data before outputting the encoded data to the image decoding device 500. In that case, while decoding the encoded data S(v) in the image decoding device 500 according to the second embodiment, there is an advantage that inverse transformation and quantization need not be performed by the inverse transformation/inverse quantization unit 514.

Third Modification

Meanwhile, the obtaining unit 107 and the generating unit 108 in the image encoding device 100 as well as the obtaining unit 507 and the generating unit 508 in the image decoding device 500 can be configured to use the pixel values of the shared block as the encoding information to be shared. For example, since the target macroblock for encoding and the shared block are macroblock capturing the same spot, there is a high correlation between the pixel values in those macroblocks. For that reason, if the obtaining units 107 and 507 determine the pixel values of the shared block as the encoding information, and if the generating units 108 and 508 generate a pixel image by copying those pixel values without modification; then it becomes possible to reduce the amount of encoding required for the encoding of the target block for encoding.

In this way, in the case when the pixel values of the shared block are used as the encoding information to be shared, the image encoding device 100 can be configured in such a way that the obtaining unit 107 obtains the pixel values of the shared block as the encoding information; the generating unit 108 generates a prediction image by copying the obtained pixel values of the shared block; and the variable-length encoding unit 118 encodes determination information, which indicates whether the encoding information shared among the target block for encoding and the shared block includes information for performing encoding such as the prediction mode, the motion vector, and the reference image specification or includes the pixel values of the shared block; and then appends the determination information in the encoded form to the encoded data.

On the other hand, the image decoding device 500 can be configured in such a way that the variable-length decoding unit 504 decodes the determination information included in the encoded data S(v) that is received; the obtaining unit 507 obtains, when the determination information indicates that the pixel values of the shared block are the encoding information, the pixel values of the shared block as the encoding information; and the generating unit 508 generates a prediction image by copying the obtained pixel values of the shared block.

Fourth Modification

Meanwhile, the method of specifying the shared block is not limited to the method of using the shared block specifying information that includes the information indicating the viewpoint of a reference image and the information indicating the relative position of the shared block from the corresponding block. For example, it is possible to implement a method in which the sequence of operations for determining the shared block can be fixed in advance between the image encoding device 100 and the image decoding device 500, and the shared block can be specified according to that sequence of operations. That enables achieving reduction in the amount of encoding required for specifying the shared block.

For example, as an example of such a sequence of operations, the setting units 106 and 506 can be configured to search, based on the trend of the encoding information in the already-encoded macroblocks adjacent to the target macroblock for encoding, for such a position in the search area formed around the corresponding block at which the correlation of the encoding information is highest, and then to determine the macroblock at the retrieved position to be the shared block.

Thus, in the image encoding device 100, the setting unit 106 is configured to set the shared block based on the trend of the encoding information in the macroblocks in a search area from a search range that is determined on the basis of the already-decoded depth information D(v) of the input image I(v) and the positional relationship between the camera that captured the input image and the camera that captured an already-decoded parallax image R(v′) at a different viewpoint. Moreover, the setting unit 106 can be configured to generate, as the shared block specifying information, determination information which indicates that the shared block is set based on the trend of the encoding information in the macroblocks in a search area from the search range mentioned above.

When the determination information in the shared block specifying information indicates that the shared block is determined based on the trend of the encoding information in the macroblocks in a search area from the search range mentioned above, the setting unit 506 in in the image decoding device 500 can set the shared block from that search range based on the trend of the encoding information.

Meanwhile, the image encoding device 100 according to the first embodiment and the modifications thereof as well as the image decoding device 500 according to the second embodiment and the modifications thereof has a hardware configuration that includes a control device such as a CPU; a memory device such as a read only memory (ROM) or a RAM; an external memory device such as an HDD or a CD drive; a display device such as a display equipment; and an input device such as a keyboard or a mouse.

An image encoding program executed in the image encoding device 100 according to the first embodiment and the modifications thereof as well as an image decoding program executed in the image decoding device 500 according to the second embodiment and the modifications thereof is stored in advance in a ROM or the like.

Alternatively, the image encoding program executed in the image encoding device 100 according to the first embodiment and the modifications thereof as well as the image decoding program executed in the image decoding device 500 according to the second embodiment and the modifications thereof can be recorded in the form of an installable or executable file on a computer-readable recording medium such as a CD-ROM, a flexible disk (FD), a CD-R, or a digital versatile disk (DVD) as a computer program product.

Still alternatively, the image encoding program executed in the image encoding device 100 according to the first embodiment and the modifications thereof as well as the image decoding program executed in the image decoding device 500 according to the second embodiment and the modifications thereof can be saved in a downloadable manner on a computer connected to a network such as the Internet. Still alternatively, the image encoding program executed in the image encoding device 100 according to the first embodiment and the modifications thereof as well as the image decoding program executed in the image decoding device 500 according to the second embodiment and the modifications thereof can be distributed over a network such as the Internet.

The image encoding program executed in the image encoding device 100 according to the first embodiment and the modifications thereof includes modules for each of the abovementioned constituent elements (the subtractor, the transformation/quantization unit, the variable-length encoding unit, the inverse transformation/inverse quantization unit, the adder, the setting unit, the obtaining unit, and the generating unit). In practice, a CPU (processor) reads the image encoding program from the ROM mentioned above and runs it so that the image encoding program is loaded in a main memory device. As a result, the module for each of the subtractor, the transformation/quantization unit, the variable-length encoding unit, the inverse transformation/inverse quantization unit, the adder, the setting unit, the obtaining unit, and the generating unit is generated in the main memory device. Meanwhile, alternatively, the abovementioned constituent elements of the image encoding device 100 can be configured with hardware such as circuits.

The image decoding program executed in the image decoding device 500 according to the second embodiment and the modifications thereof includes modules for each of the abovementioned constituent elements (the variable-length decoding unit, the inverse transformation/inverse quantization unit, the adder, the setting unit, the obtaining unit, and the generating unit). In practice, a CPU (processor) reads the image decoding program from the ROM mentioned above and runs it so that the image decoding program is loaded in a main memory device. As a result, the module for each of the variable-length decoding unit, the inverse transformation/inverse quantization unit, the adder, the setting unit, the obtaining unit, and the generating unit is generated in the main memory device. Meanwhile, alternatively, the abovementioned constituent elements of the image decoding device 500 can be configured with hardware such as circuits.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image encoding device comprising:
a setting unit configured to
set an corresponding block corresponding to a target block to be encoded in a first parallax image at a first viewpoint on the basis of first depth information of the first parallax image and a positional relationship between the first viewpoint and a second viewpoint of each of one or more second parallax images, the corresponding block being in the one or more second parallax images,
set a shared block in a search area including the target block and area adjacent to the corresponding block, the shared block whose encoding information is shared and
generate specifying information that indicates a positional relationship between the shared block and the corresponding block;
an obtaining unit configured to obtain the encoding information of the shared block on the basis of the specifying information;
a generating unit configured to generate a prediction image on the basis of the obtained encoding information; and
an encoding unit configured to generate encoded data based on the image and the prediction image.

2. The image encoding device according to claim 1, wherein the encoding unit further encodes the specifying information, and generates the encoded data to which the encoded specifying information is appended.

3. The image encoding device according to claim 1, wherein
the obtaining unit obtains pixel values of the shared block included in the encoding information,
the generating unit generates the prediction image on the basis of the obtained pixel values of the shared block, and
the encoding unit further encodes determination information which indicates that the encoding information includes the pixel values of the shared block, and appends the encoded determination information to the encoded data.

4. The image encoding device according to claim 1, wherein
the setting unit searches the shared block in the search area on the basis of a trend of the encoding information in the search area, the search area being determined on the basis of the first depth information and a positional relationship between imaging devices.

5. An image decoding device comprising:
a setting unit configured to
set an corresponding block according to a target block to be encoded in a first parallax image at a first viewpoint on the basis of first depth information of the first parallax image and a positional relationship between the first viewpoint and a second viewpoint of a second parallax image, the corresponding block being in the second parallax image, and
set a shared block whose encoding information is shared on the basis of specifying information that indicates a positional relationship between the shared block and the corresponding block;
an obtaining unit configured to obtain the encoding information of the shared block on the basis of the specifying information;
a generating unit configured to generate a prediction image on the basis of the obtained encoding information; and
a decoding unit configured to decode encoded data that is received and generate an output image based on the decoded, encoded data and the prediction image.

6. The image decoding device according to claim 5, wherein
the encoded data includes the encoded specifying information,
the decoding unit further receives the encoded data from an image encoding device and decodes the specifying information included in the encoded data, and
the setting unit sets the shared block on the basis of the decoded specifying information.

7. The image decoding device according to claim 6, wherein
the encoded data further includes determination information that indicates whether the encoding information includes pixel values of the shared block, the determination information being encoded,
the decoding unit decodes the determination information,
when the determination information indicates that the encoding information includes the pixel values of the shared block, the obtaining unit obtains the pixel values of the shared block, and
the generating unit generates the prediction image on the basis of the obtained pixel values of the shared block.

8. The image decoding device according to claim 6, wherein
the specifying information further includes determination information that indicates whether the shared block is searched in a search area on the basis of a trend of the encoding information in the search area, the search area including the target block and area adjacent to the corresponding block, the search area being determined on the basis of the first depth information and a positional relationship between imaging devices, and
when the determination information indicates that the shared block is to be searched in the search area, the setting unit sets the shared block in the search area on the basis of the trend of the encoding information.

9. An image encoding method comprising:
setting an corresponding block corresponding to a target block to be encoded in a first parallax image at a first viewpoint on the basis of first depth information of the first parallax image and a positional relationship between the first viewpoint and a second viewpoint of each of one or more second parallax images, the corresponding block being in the one or more second parallax images;
setting a shared block in a search area including the target block and area adjacent to the corresponding block, the shared block whose encoding information is shared;
generating specifying information that indicates a positional relationship between the shared block and the corresponding block;
obtaining the encoding information of the shared block on the basis of the specifying information;
generating a prediction image on the basis of the obtained encoding information; and
generating encoded data based on the image and the prediction image.

10. An image decoding method comprising:
setting an corresponding block according to a target block to be decoded in a first parallax image at a first viewpoint on the basis of first depth information of the first parallax image and a positional relationship between the first viewpoint and a second viewpoint of a second parallax image, the corresponding block being in the second parallax image;
setting a shared block whose encoding information is shared on the basis of specifying information that indicates a positional relationship between the shared block and the corresponding block;
obtaining the encoding information of the shared block on the basis of the specifying information;
generating a prediction image on the basis of the obtained encoding information; and
decoding encoded data that is received and generating an output image based on the decoded, encoded data and the prediction image.

11. A computer program product comprising a computer-readable medium containing a program executed by a computer, the program causing the computer to execute:
setting an corresponding block corresponding to a target block to be encoded in a first parallax image at a first viewpoint on the basis of first depth information of the first parallax image and a positional relationship between the first viewpoint and a second viewpoint of each of one or more second parallax images, the corresponding block being in the one or more second parallax images;
setting a shared block in a search area including the target block and area adjacent to the corresponding block, the shared block whose encoding information is shared;
generating specifying information that indicates a positional relationship between the shared block and the corresponding block;
obtaining the encoding information of the shared block on the basis of the specifying information;
generating a prediction image on the basis of the obtained encoding information; and
generating encoded data based on the image and the prediction image.

12. A computer program product comprising a computer-readable medium containing a program executed by a computer, the program causing the computer to execute:
setting an corresponding block according to a target block to be decoded in a first parallax image at a first viewpoint on the basis of first depth information of the first parallax image and a positional relationship between the first viewpoint and a second viewpoint of a second parallax image, the corresponding block being in the second parallax image;
setting a shared block whose encoding information is shared on the basis of specifying information that indicates a positional relationship between the shared block and the corresponding block;
obtaining the encoding information of the shared block on the basis of the specifying information;
generating a prediction image on the basis of the obtained encoding information; and
decoding encoded data that is received and generating an output image based on the decoded, encoded data and the prediction image.
